(19) United States
(12) Patent Application Publication
(10) Pub. No.: US 2008/0074873 A1
(43) Pub. Date: Mar. 27, 2008

(54) Wall lamp

(76) Inventor: Ming-Kuei Lin, Panchiao City (TW)

Correspondence Address: TROXELL LAW OFFICE PLLC, SUITE 1404, 5205 LEESBURG PIKE, FALLS CHURCH, VA, 22041, US

(21) Appl. No.: 11/526,068

(22) Filed: Sep. 25, 2006

(51) Int. Cl. F21V 5/00

(52) U.S. Cl. 362/235; 362/311

(57) ABSTRACT

A wall lamp includes a conical refractor having a plurality of radial wave surfaces and is fixed in a space between a front cover and a rear cover so that outer edge of a bottom surface of the conical refractor is covered by the rear cover while a conical surface of the conical refractor is exposed through a window on the front cover. The conical surface is exposed toward the same direction with pins on a base. An LED is disposed on the center of the bottom surface of the conical refractor and light emitted from the LED radiates from the center of the bottom surface into inner side of the transparent conical refractor, then projects onto the wall. Thus radial lighting pattern is shown on the wall.

### BACKGROUND OF THE INVENTION

The present invention relates to a wall lamp, especially to a lamp that uses at least one LED (light emitting diode) as a light source and light emitted from the LED is refracted by a cone to form radiated light with shadows on the wall. Therefore, the decorative effect and safety of the wall lamp are improved and the lamp is power-saving.

Generally, wall lamps or analogues such as night lamps are arranged on walls of passages, walkways or rooms and are controlled by a switch or a sensor so as to light the lamps at night or in the dark. However, conventional wall lamps include a small heat-generated bulb as a light source and a transparent stylish housing covered the whole or part of the bulb. Thus the lamps are not only for lighting but also as ornaments. The small light bulb consumes power a lot and also has safety problems after being used for a period of time with increased temperature. Moreover, the design of the housing is monotonous without novelty appearance. Refer to US patent publication No. 2006/0067074 A1, published on Mar. 30, 2006, a transparent conical refractor with radial wave surface is disclosed by the same inventor of the present invention. Although it's a new design, the inventor stops production of such lamps because of large volume and high cost. The present invention is designed based on the conical refractor.

### SUMMARY OF THE INVENTION

Therefore it is a primary object of the present invention to provide a wall lamp that consists of a base, a front cover, a rear cover, at least one LED, and a transparent conical refractor. The base includes a LED circuit board for controlling LED lighting patterns therein, and pins for plugging into a socket on a wall arranged on one side thereof. A transparent conical refractor is secured between the front cover and the rear cover and outer edge of a bottom surface of the conical refractor is covered by the covers. At least one LED is disposed on the center of the bottom surface of the conical refractor. The transparent conical refractor having a conical surface that is exposed outside the front cover and is toward the same direction with pins on the base. A plurality of radial wave surfaces is arranged on the conical surface. Thereby, light emitted from the LED is refracted by the transparent conical refractor and then projects onto the wall so as to show radial lighting pattern. Therefore, the decorative effect, safety and energy saving function of the wall lamp are increased.

### BRIEF DESCRIPTION OF THE DRAWINGS

FIG. 1 is a perspective view of an embodiment according to the present invention;

FIG. 2 is an explosive view of the embodiment in FIG. 1;

FIG. 3 is a schematic drawing showing using status of the embodiment in FIG. 1;

FIG. 4 is a partial cross-sectional view of the embodiment in FIG. 3;

FIG. 5 is a schematic drawing showing light emitted from the embodiment in FIG. 3.

### DETAILED DESCRIPTION OF THE PREFERRED EMBODIMENT

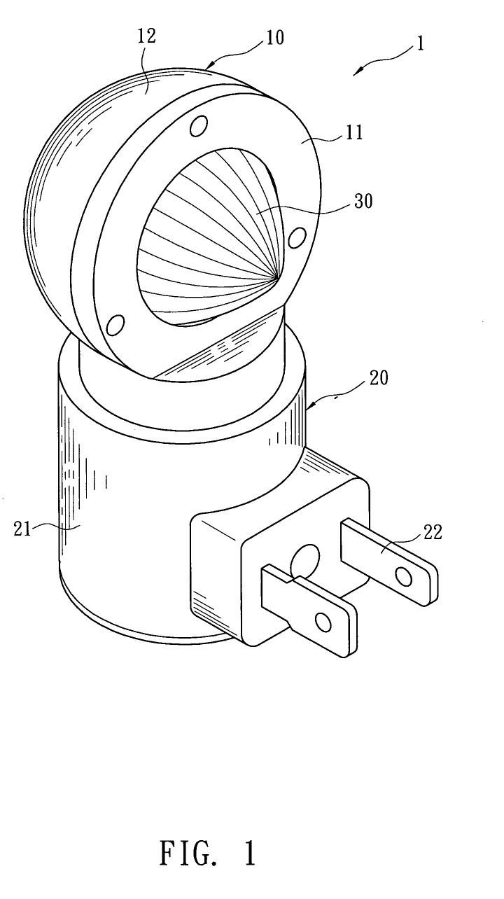

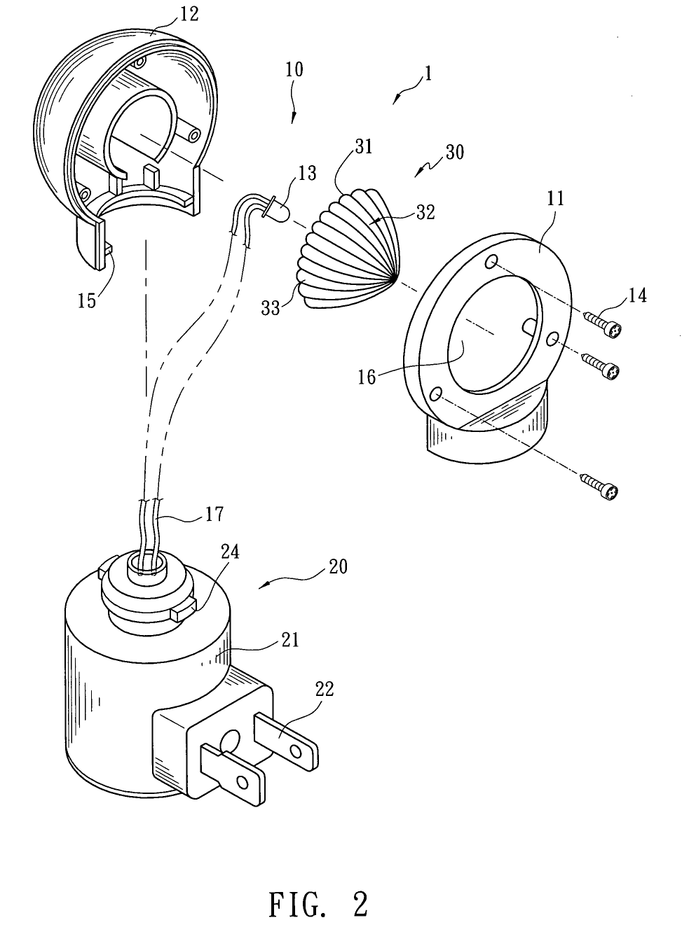

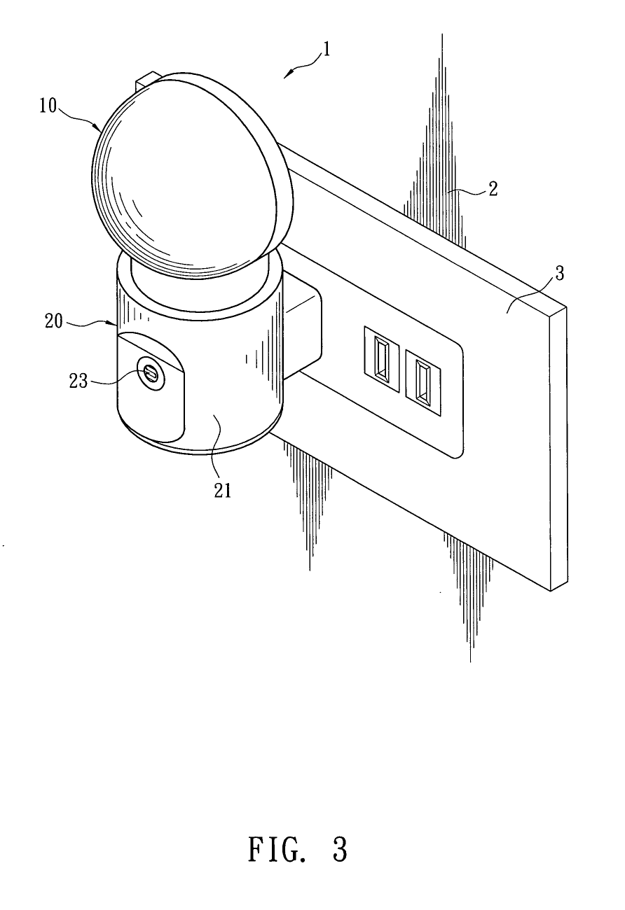

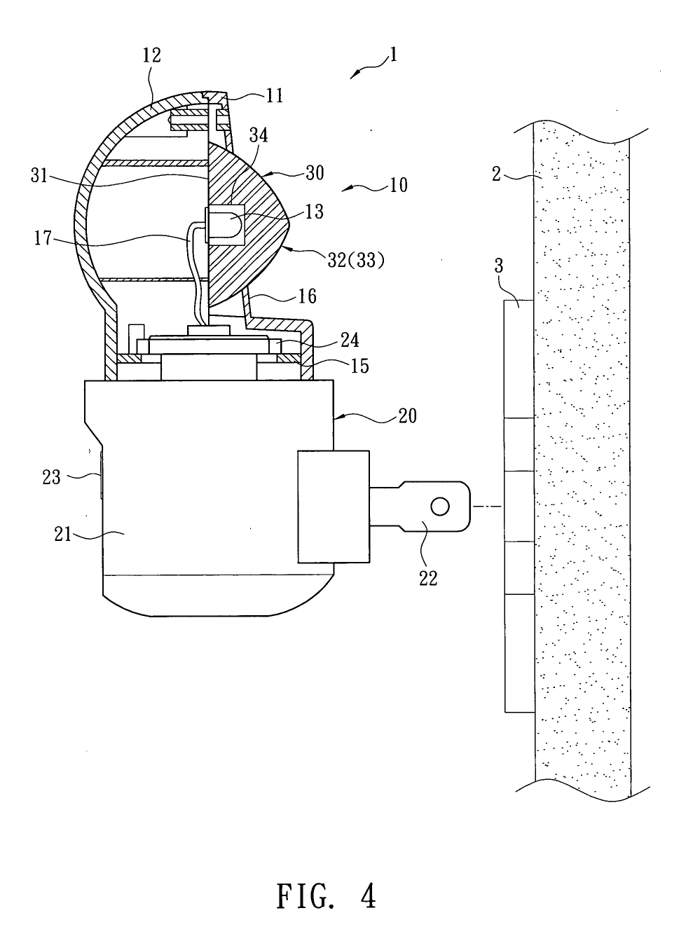

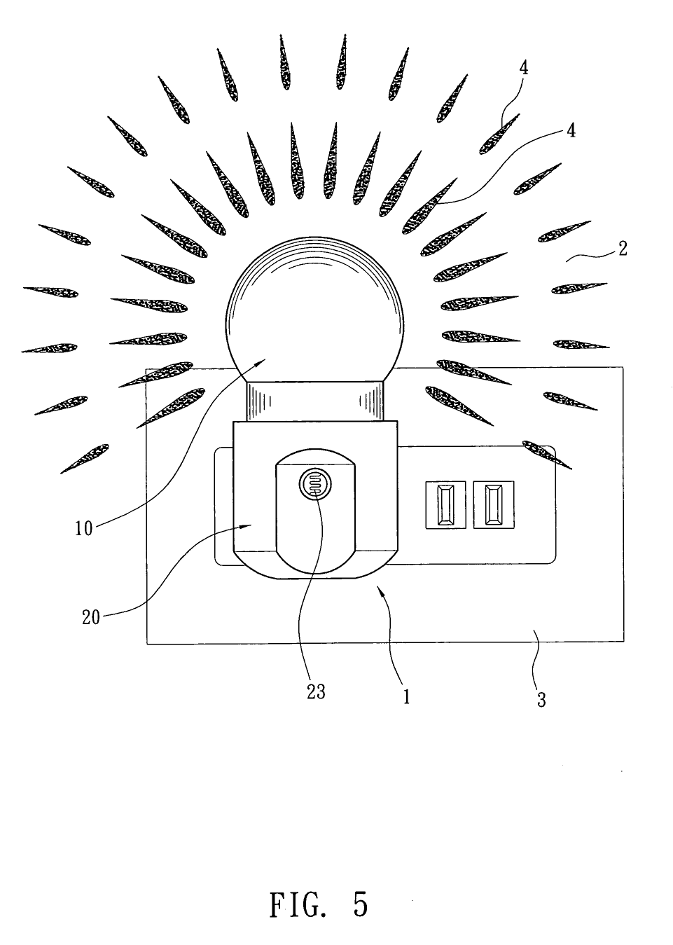

Refer from FIG. 1 to FIG. 5, a wall lamp according to the present invention includes a light-emitting part 10 on an upper part and a base 20 on a lower part. The base 20 consists of a housing 31 with electronic components such as a LED circuit board (not shown in figure) for controlling lighting patterns of an LED 13 therein and a set of pins 22 for plugging into a socket 3 on a wall 22 (as shown in FIG. 3 & FIG. 4). A sensor switch 23 (or a push-button switch, not shown in figure) for turning on or off the LED 13 is arranged on the housing 21, opposite to the position of the pins 22 while a connecting member 24 is disposed on upper part of the housing for connecting with the light-emitting part 10. The light-emitting part 10 is composed by a front cover 11, a rear cover 12, an LED 13 and a transparent conical refractor 30. The front cover 11 and the rear cover 12 are integrated with each other and there is no restriction on the way they connected with each other. They can be assembled by threaded with screws 14, as shown in FIG. 2 or other ways such as fastening. A connecting member 15 is formed on the assembly of the front cover 11 and the rear cover 12, corresponding to and connecting with the connecting member 24 of the base 20. There is no limit on connecting way between the connecting member 15 and the connecting member 24 such as locking, fastening, mounting. A transparent conical refractor 30 is a transparent cone made from plastic injection molding. The shape of the transparent conical refractor 30 (bottom surface 31 thereof) is a cone or a pyramid. A plurality of radial wave surfaces 33 is disposed on a conical surface 32 of the conical refractor 30. The conical refractor 30 is secured in a space between the front cover 11 and the rear cover 12 so that outer edge of the bottom surface 3 1 is covered by the rear cover 12 while the conical surface 32 is exposed through a window 16 with the same shape of the conical surface 32 of the front cover 11. The conical surface 32 is exposed toward the same direction with the pins 22 of the base 20. The LED 13 can be one LED or a plurality of LEDs with the same or different color. Take an LED 13 as a example, refer to FIG. 2 and FIG. 4, the LED 13 is connected with the LED circuit board inside the base 20 by a wire 17. Moreover, the LED 13 is disposed on the center of the bottom surface 31 of the conical refractor 30 and light emitted from the LED 13 radiates vertically from the center of the bottom surface 31 into inner side of the transparent conical refractor 30. In accordance with above structure, when LED 13 emits light, light passes through the conical refractor 30 and the projects to the wall 2. By refraction of the plurality of radial wave surfaces 33 on the conical surface 32 of the conical refractor 30, light from LED 13 shows radial lighting pattern 4 on the wall 2, as shown in FIG. 5. Therefore, decorative effect of wall lamps is improved.

Furthermore, a slot indenting inwards 34 is arranged on center of the bottom surface 31 of the conical refractor 30 so that the LED 13 is easy to be mounted and located inside the indenting slot 34. This is convenient for assembling between the LED 13 and the conical refractor 30. In addition, lighting patterns of the LED 13 are controlled by the LED circuit board inside the base 20. For example, the LED 13 can emit light continuously or twinkling. Or a plurality of LEDs 13 lights in alternative way. Thus the variety of lighting patterns and decorative effect of the LED 13 are enhanced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A wall lamp comprising a light-emitting part on an upper part and a base on a lower part thereof, wherein
the base having a housing with electronic components as well as a LED circuit board therein, a set of pins for plugging into a socket on a wall arranged on one side thereof and a switch for turning on or off an LED of the lighting part arranged on the housing, opposite to the position of the pins; and upper part of the base is integrated with the lighting part;
the lighting part connected on top of the base having a front cover, a rear cover, the LED and a transparent conical refractor; the front cover and the rear cover are integrated with each other while the transparent conical refractor having a conical surface disposed with a plurality of f radial wave surfaces is fixed in a space between the front cover and the rear cover so that outer edge of a bottom surface thereof is covered by the rear cover and the conical surface is exposed through a window on the front cover, facing the same direction with pins of the base; the LED is disposed on the center of the bottom surface of the conical refractor and light emitted from the LED radiates from the center of the bottom surface into inner side of the transparent conical refract;
thereby light emitted from the LED is refracted by the plurality of radial wave surfaces on the conical surface of the transparent conical refract and then projects to the wall to form radial lighting patterns for increasing decorative effect of the wall lamp.

2. The wall lamp as claimed in claim 1, wherein the conical refractor is a cone or a pyramid.

3. The wall lamp as claimed in claim 1, wherein the LED having at least one LED or a plurality of LED with the same or different colors and the LED is connected with the LED circuit board inside the base by a wire.

4. The wall lamp as claimed in claim 1, wherein the switch is a sensor switch or a push-button switch.

5. The wall lamp as claimed in claim 1, wherein a slot indenting inwards for mounting and locating the LED is arranged on center of the bottom surface of the conical refractor.

6. The wall lamp as claimed in claim 1, wherein lighting patterns of the LED is controlled by the LED circuit board and the lighting patterns having continuously lighting, twinkling or in alternative way.
